(19) United States
(12) Patent Application Publication
(10) Pub. No.: US 2021/0056815 A1
(43) Pub. Date: Feb. 25, 2021

(54) METHOD AND SYSTEM FOR HOSTING A MULTI-PLAYER POKER GAME WITH AN INSURANCE MECHANISM

(71) Applicant: ARION LABS CO., LTD., Taipei City (TW)

(72) Inventors: Chan-Guan KOH, Taipei City (TW); Yu-Song WU, Taipei City (TW); Tai-You TAN, Taipei City (TW); Hong-Wei CHANG CHANG, Taipei City (TW); Tze-Wen Glenn QUAN, Taipei City (TW); Ming-Jie NG, Taipei City (TW); Chin-Yuan CHEN, Taipei City (TW); Zhuang-Chean KOH, Taipei City (TW); Jun-Long SIM, Taipei City (TW); Zhuang-Sheng KOH, Taipei City (TW); Wen-Biao NG, Taipei City (TW)

(21) Appl. No.: 16/879,181

(22) Filed: May 20, 2020

(30) Foreign Application Priority Data
Aug. 23, 2019 (TW) 108130255

(51) Int. Cl. G07F 17/32

(52) U.S. Cl. CPC G07F 17/3293; G07F 17/3276; G07F 17/3258

(57) ABSTRACT

A method for hosting a poker game for a plurality of players includes: when an all-in bet among at least two players has occurred, and when a predetermined insurance condition is met, providing the leading player with an option to purchase an insurance with respect to the at least one out; when the at least one out is dealt as a turn card and the leading player has purchased the insurance covering the out, paying the leading player a payout; and when it is determined that the leading player has purchased the insurance, and the at least one out is not dealt at the turn stage, a user-designated insurance premium is collected from the leading player.

### CROSS-REFERENCE TO RELATED APPLICATION

This application claims priority of Taiwanese Patent Application No. 108130255, filed on Aug. 23, 2019.

### FIELD

The disclosure relates to a method and a system for hosting a multi-player poker game, more particularly to a method and a system for hosting a multi-player poker game with an insurance mechanism.

### BACKGROUND

A conventional community card poker game for a plurality of players (such as Texas hold'em, Omaha hold'em, and many variations thereof) is typically hosted in the following manner.

Firstly, each of the players is dealt privately a predetermined number (e.g., two or four) of hole cards (an incomplete hand). Afterward, abetting round (which is named a pre-flop round) is held where the players take turns in making a betting option to check, call, raise or fold. An amount of chips or money betted by the players is called the pot.

Then, a total of five community cards are dealt face up in three stages (i.e., a flop stage, a turn stage and a river stage). In the flop stage, three community cards (known as flop cards) are dealt. After the flop cards are dealt, another betting round is held. Then, the game proceeds to the turn stage where one community card (known as turn card) is dealt. After the turn card is dealt, another betting round is held. Then, the game proceeds to the river stage where another one community card (known as river card) is dealt. After the river card is dealt, another betting round is held and a final showdown occurs. On the final showdown, each player who has not folded yet reveals his or her hole cards to make a best five card poker hand that is selected from the hole cards and the community cards and is a subset of the hole cards and the community cards.

It is noted that, one or more players may go “all in” prior to the final showdown and are unable to participate in the subsequent betting round(s). In such a case, the original pot including the chips or money contributed by the player(s) that went all in is closed, and a separate pot without the input of the player(s) who have gone all in will be created for other players. In a single game, multiple pots may be created each being associated with a specific subset of different players. On the showdown, a winner of each of the pots is determined separately among the associated players.

In some cases (e.g., in an online platform), when more than one player has gone all in at a same betting round, a showdown may occur and the hole cards of the players who have gone all in may be revealed among those players.

### SUMMARY

Therefore, an object of the disclosure is to provide a method for hosting a multi-player poker game with an insurance mechanism.

According to one embodiment of the disclosure, the method is implemented using a computer system and includes steps of:

a) initiating the poker game with a plurality of players, the poker game including an initial stage where at least two hole cards are dealt to each of the players from a stack of cards (such as a standard 52-card deck), a flop stage where three community cards are dealt, a turn stage where one additional community card is dealt, and a river stage where one additional community card is dealt, wherein each of the players is permitted to make bet at each stage into at least one pot;

b) after the flop stage and before the turn stage, determining whether an all-in bet has occurred;

c) when the determination of step b) is affirmative, determining whether a predetermined insurance condition is met, the predetermined insurance condition indicating that in the pot, for a leading player who contributed to the pot and has a hand, which is constituted by the hole cards and the community cards, that has a highest rank, there exists at least one lead out in the stack of cards that has not yet been dealt and that, when dealt in the turn stage, enables another one of the players who contributed to the pot to have a hand with a highest rank;

d) when the determination of step c) is affirmative, providing the leading player with an option to purchase a turn-card insurance against the at least one lead out with a user-designated insurance premium; and

e) at the turn stage, when it is determined that the turn card actually dealt is a lead out covered by the turn-card insurance, paying the leading player a payout based on the user-designated insurance premium, and when it is determined that the turn card actually dealt is not a lead out covered by the turn-card insurance, collecting the user-designated insurance premium from the leading player (that is, the user-designated insurance premium is to be collected from the leading player).

Another object of the disclosure is to provide a computer system that is capable of implementing the above-mentioned method.

According to one embodiment of the disclosure, the computer system includes a database that stores a software application therein, a communication component, and a processor. The communication component is configured to communicate with a plurality of electronic devices. Each of the plurality of electronic devices is operated by a player. The processor is electrically connected to the database and the communication component, and is configured to execute the software application so as to perform the steps of the above-mentioned method.

Another object of the disclosure is to provide a non-transitory computer readable data storing medium that stores instructions therein that, when executed by a processor of a computer, cause the processor to perform steps of the above-mentioned method.

### BRIEF DESCRIPTION OF THE DRAWINGS

Other features and advantages of the disclosure will become apparent in the following detailed description of the embodiments with reference to the accompanying drawings, of which:

FIGS. 1A and 1B cooperatively form a flow chart illustrating steps of a method for hosting a multi-player poker game with an insurance mechanism according to one embodiment of the disclosure;

FIG. 2 is a block diagram illustrating an exemplary computer system for hosting a multi-player poker game with an insurance mechanism according to one embodiment of the disclosure;

FIG. 3 illustrates an exemplary virtual table that includes nine seats for playing a poker game;

FIG. 4 illustrates a “buy insurance” window displayed for a leading player;

FIG. 5 illustrates one condition in which two players have the same hand value of their hole cards (which means there are more than one leading player), so the option to purchase insurance is not provided;

FIG. 6 illustrates one condition in which an amount of chips in the pot is smaller than a predetermined number, so the option to purchase insurance is not provided;

FIG. 7 illustrates one condition in which a main pot and a side pot are present and the leading player for the main pot may purchase insurance for a turn card;

FIG. 8 illustrates one condition in which a main pot and a side pot are present and the leading player for the side pot may purchase insurance for a turn card;

FIG. 9 illustrates one condition in which there are a number of lead outs and a number of chop outs and the leading player may purchase insurance with respect to any one of the lead outs or the chop outs;

FIG. 10 illustrates the virtual table in a turn stage, in which insurance has been purchased;

FIG. 11 illustrates a “buy insurance” window displayed for a leading player;

FIG. 12 illustrates a condition in which mandatory insurance is imposed for the leading player;

FIG. 13 illustrates the virtual table in the turn stage, in which the insurance premium has been updated;

FIG. 14 illustrates one condition in which there are a number of lead outs and a number of chop outs and the leading player may choose to purchase insurance with respect to all of the lead outs and the chop outs and no mandatory insurance is imposed;

FIG. 15 illustrates one condition in which there are a number of lead outs and a number of chop outs and the leading player is purchasing insurance with respect to only the chop outs, necessitating purchase of a mandatory insurance;

FIG. 16 illustrates one condition in which there are a number of lead outs and a number of chop outs and the leading player is purchasing insurance with respect to only the lead outs, necessitating purchase of a mandatory insurance;

FIG. 17 illustrates the virtual table, in which the insurance premium has been updated;

FIG. 18 illustrates one condition in which there are a number of lead outs and a number of chop outs and the leading player may purchase insurance with respect to all of the lead outs and the chop outs;

FIG. 19 illustrates the virtual table, in which the insurance premium has been updated;

FIG. 20 illustrates one condition in which there are a number of lead outs and a number of chop outs and the leading player is purchasing insurance with respect to only the lead outs, necessitating purchase of a mandatory insurance; and

FIG. 21 illustrates one condition in which a maximum premium for the insurance is imposed at a certain amount.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

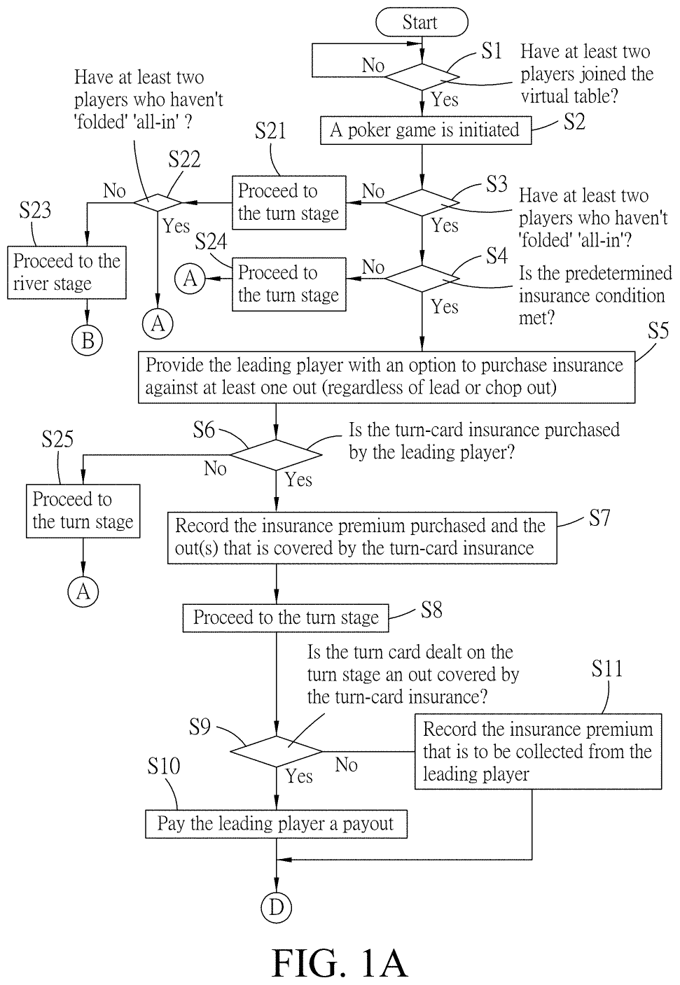

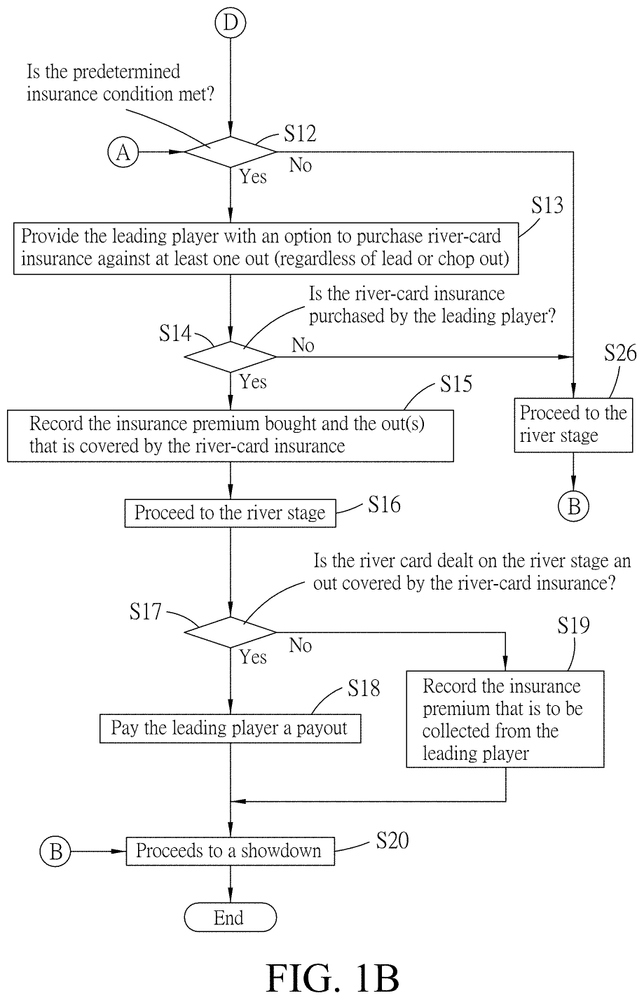

FIGS. 1A and 1B cooperatively constitute a flow chart illustrating steps of a method for hosting a multi-player poker game with an insurance mechanism according to one embodiment of the disclosure. In this embodiment, the method is implemented using a computer system.

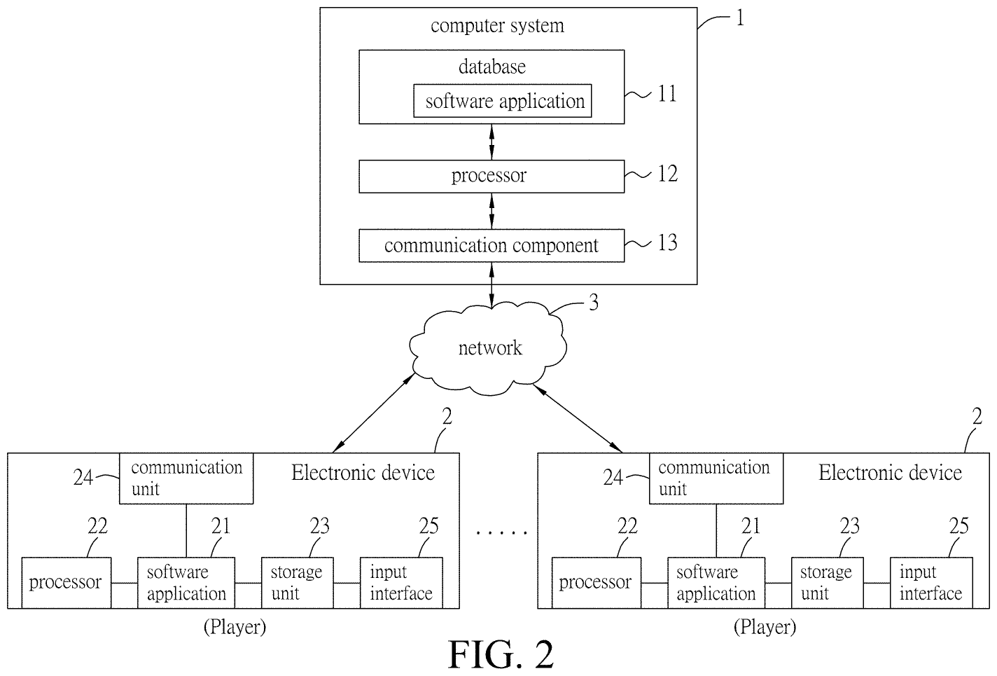

FIG. 2 is a block diagram illustrating an exemplary computer system 1 for hosting a multi-player poker game with an insurance mechanism according to one embodiment of the disclosure.

The computer system 1 may be embodied using a server device, and includes a database 11, a processor 12 and a communication component 13.

The database 11 may be embodied using a storage medium including one or more of a hard disk, a solid-state drive (SSD) and other non-transitory storage medium. The database 11 stores a software application including instructions that, when executed by the processor 12, cause the processor 12 to perform operations as described below.

The processor 12 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The communicating component 13 may include a short-range wireless communication module supporting a short-range wireless communication network using a wireless technology of Bluetooth® and/or Wi-Fi, etc., and a mobile communication module supporting telecommunications using Long-Term Evolution (LTE), the third generation (3G) and/or fourth generation (4G) of wireless mobile telecommunications technology, and/or the like. In this embodiment, the computer system 1 is capable of enabling a plurality of electronic devices 2 to communicate with the communicating component 13 via a network 3 (e.g., the Internet).

Each of the electronic devices 2 may be possessed and operated by a human user (referred to as a“player”), and may be embodied using a personal computer, a laptop computer, a tablet, a smartphone, etc. Each of the electronic devices 2 may include a processor 21 (which may be embodied using a processor similar to the processor 12), a display 22 (which may be a display screen), a storage unit 23 (which may be embodied using a hardware storage similar to the database 11), a communication unit 24 (which may be embodied using a communication unit similar to the communicating component 13), and an input interface 25 (which may be embodied using a mouse/keyboard set). In the case that the electronic device 2 is a tablet or a smartphone, the display 22 and the input interface 25 may be integrated as a touch screen.

In use, each of the players may operate the electronic device 2 possessed thereby to establish communication with the computer system 1. This may be done by executing a software application that is associated with playing a poker game and that is stored in the storage unit 23. Alternatively, the user may execute a web browser on the electronic device 2 to access a website that is associated with the computer system 1 and that provides services for playing the poker game. Then, the user may operate the electronic device 2 to perform a login operation using an account-password combination, and to join a game lobby that includes a number of virtual tables provided by the computer system 1, each for playing a poker game. In the disclosure, the poker game may be a multi-player community card poker game (such as Texas hold'em, Omaha hold'em, and many variations thereof). In this embodiment, the poker game is Texas hold'em, and includes an initial stage of privately dealing two hole cards to each of the players from a stack of cards (such as a standard 52-stack card), a flop stage where three community cards are dealt face up, a turn stage where one additional community card is dealt face up, and a river stage where one additional community card is dealt face up. Each of the players is permitted to make bet after each stage into one or more pots.

It is noted that each of the virtual tables may have a number of specific settings related to the poker game. Specifically, the settings may include one or more of a maximum number of players allowed (any number from 2 to 9) to join the poker game, a default payout odd, designated big blind and small blind (i.e., forced bets respectively by designated two of the players at the beginning of each of the games), a designated ante (i.e., a forced bet by each of the players at the beginning of each of the games), etc.

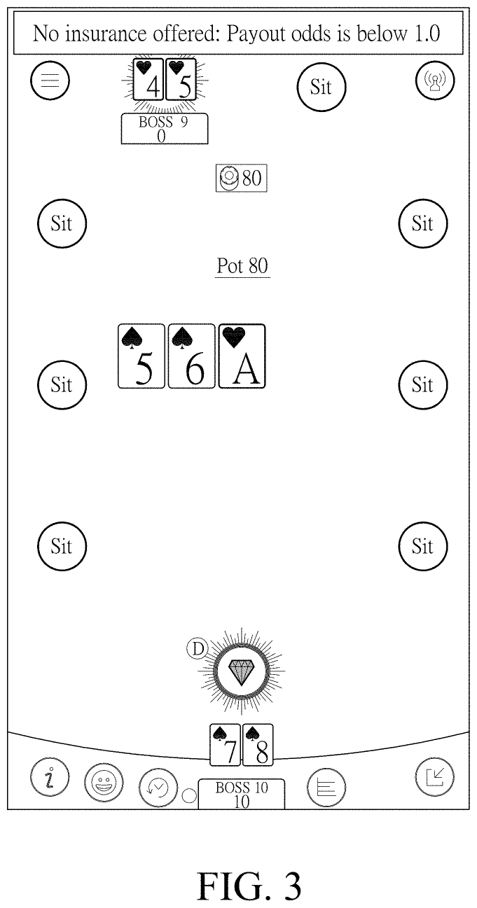

FIG. 3 illustrates an exemplary virtual table that includes nine seats for playing a poker game. After a user joins the virtual table, he or she may select one of the seats to “sit” on. In the example of FIG. 3, two players (identified as “BOSS 9” and “BOSS 10”) have joined the virtual table and sit on two different seats. Each player may purchase (using, for example, in-game currency or real-life currency) a number of chips (also known as a stack) for playing after “sitting” on the desired seat.

Referring back to FIG. 1, when the processor 12 determines in step S1 that at least two players have joined the virtual table, a poker game is initiated in step S2.

At the start of the poker game, each player is dealt a predetermined number (e.g., two or four, two in this embodiment) of hole cards (an incomplete hand) that are private to the player.

Afterward, abetting round (which is named a pre-flop round) is held where each of the players take turns in making a betting option to check (i.e., not adding any chip to the pot), call, raise or fold. An amount of chips betted by the players is called a pot.

Then, the game proceeds to the flop stage where three community cards (known as flop cards) are dealt face up. After the flop cards are dealt, each of the players has a five-card “hand” that is constituted by the two hole cards and the three community cards. Additionally, another betting round is held.

At this stage, in step S3, the processor 12 determines whether an all-in bet has occurred.

Specifically, the term “all-in bet” refers to a condition that a player goes “all in” at or prior to this stage (i.e., the player bets all of the chips the player has at the table), and is unable to participate in the subsequent betting. In such a case, the original pot is closed, and a separate pot (called side pot) without the input of the player(s) who have gone all in will be created for other players for the subsequent betting. In various stages of a single game, multiple pots may be created each being associated with a specific subset of different players.

When it is determined that an all-in bet has occurred, the flow proceeds to step S4. Otherwise, the flow proceeds to step S21, in which the game proceeds to the turn stage where one community card (known as turn card) is dealt face up. After the turn card is dealt, another betting round is held.

In step S4, the processor 12 determines, individually for each pot, whether a predetermined insurance condition is met. When it is determined that the insurance condition is met, the flow proceeds to step S5. Otherwise, the flow proceeds to step S24, in which the game proceeds to the turn stage.

It is noted that the insurance condition indicates one or more specific scenarios. For example, in this embodiment, the insurance condition indicates a first scenario that in the pot, there is a leading player among those players who contribute to the pot and who has a hand that has a highest rank, and a second scenario that there exists at least one “lead out”. It should be noted that the insurance condition is met only when the first and second scenarios both occur in this embodiment.

In the disclosure, the term “lead out” refers to a card in the stack of cards that is not yet dealt and that, when dealt in the turn stage, enables another player who is not the leading player before the lead out is dealt to have a hand with a highest rank (i.e., to become the leading player for the pot).

That is to say, in the cases where the insurance condition is met, there is a leading player who, after the flop stage, may be overtaken by other players in the subsequent stages because of the possibility of the lead out being dealt. In such a condition, the flow proceeds to step S5, in which the processor 12 provides the leading player with an option to purchase, with a user-designated insurance premium, insurance against an event that the at least one lead out is dealt in the turn stage. For example, a “buy insurance” window may pop up at the display 22 of the electronic device 2 of the leading player. Additionally, the processor 2 calculates a first payout odd associated with the insurance against the at least one lead out in step S5.

It is noted that insurance purchased in the flop stage covers only the next dealt card (i.e., the turn card), and is referred to as turn-card insurance hereinafter.

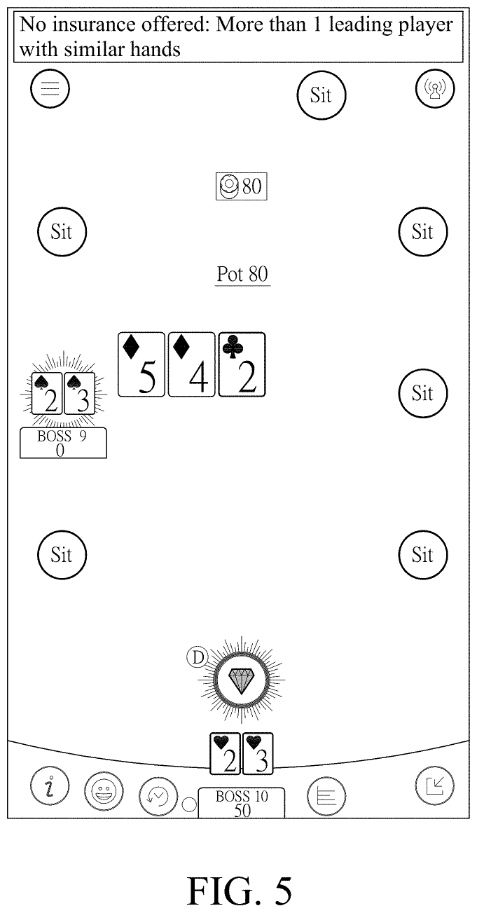

In some examples, the insurance condition may include one or more exceptions. For example, in FIG. 5, the two players have the same hand value of their hole cards. As a result, the resulting hands of the players at the flop stage would have a same rank. In such a case, the option to purchase the turn-card insurance is not provided. It is noted that, in the case that more than three players are present, when two players are deemed to be the leading players having their hand with a same rank, the option to purchase the turn-card insurance is not provided to any one of the leading players.

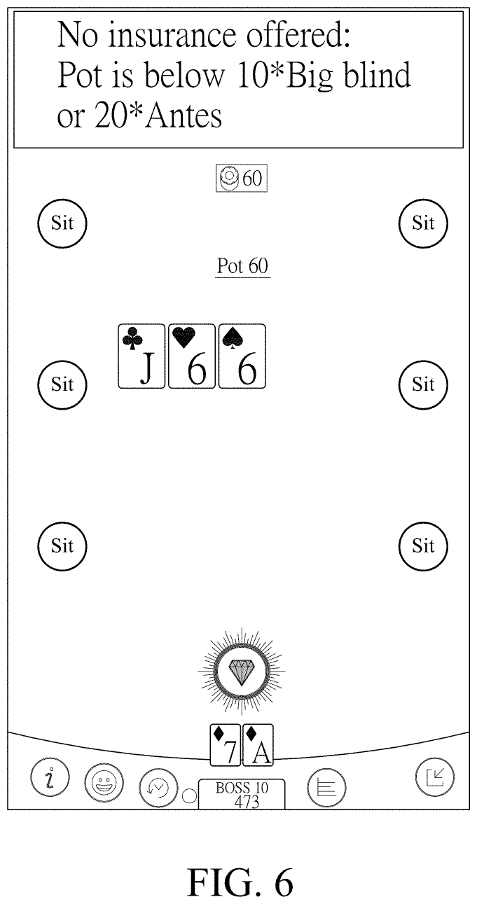

In another example, when an amount of the pot is smaller than a predetermined number, the option to purchase the turn-card insurance is not provided to the leading player. As shown in FIG. 6, the predetermined number may be ten times the big blind or 20 times the designated ante.

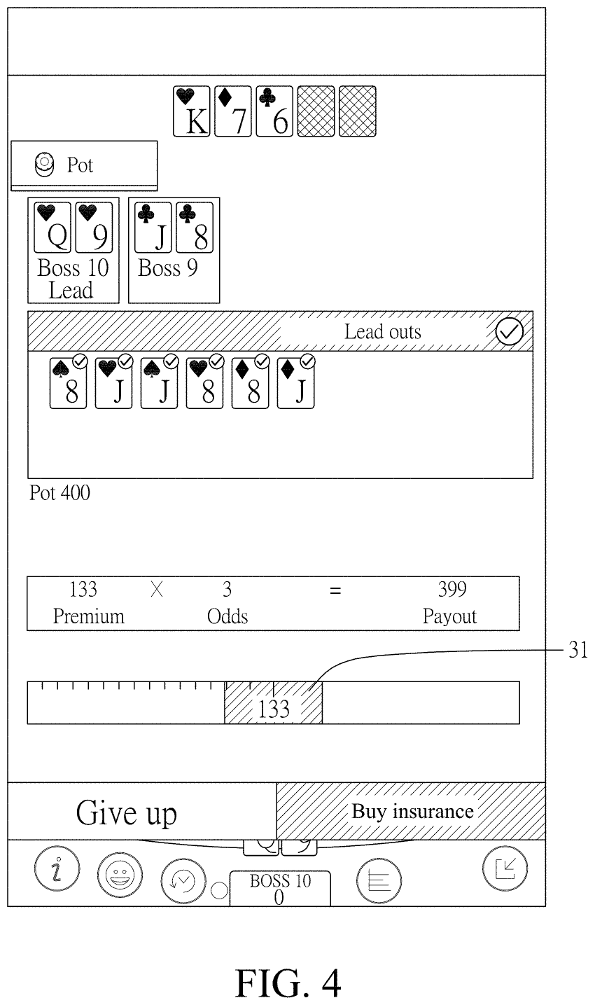

As shown in FIG. 4, the player “Boss 10” is the leading player over the player “Boss 9” since his or her hand (high card with King and Queen) has a higher rank than that of the player Boss 9 (high card with King and Jack).

It is determined that there are six possible lead outs (the three Jacks and three eights) that can make Boss 9's hand (one pair) better than Boss 10's hand (high card with King). As a result, the “buy insurance” window is popped up as shown in FIG. 4 for Boss 10. The player Boss 10 may then decide whether to purchase the turn-card insurance against one or more of the lead outs. It should be noted that, in the event that the player Boss 10 decides to purchase the turn-card insurance, the player Boss 10 may further decide which lead out(s) would be covered by the insurance. The turn-card insurance is purchased to ensure that a payout will be reimbursed to the player Boss 10 (the leading player) when the player Boss 10 relinquishes the leading position after the turn stage because a lead out covered by the turn-card insurance is dealt in the turn stage.

Specifically, an amount of the payout may be calculated based on a user-designated insurance premium and the payout odd of the turn-card insurance (e.g., a first payout odd). The user-designated insurance premium is an amount of chips spent by the leading player in purchasing the insurance covering the user-selected lead out(s), and may be designated by the leading player through moving a slider bar 31 on the buy insurance window. It is noted that the payout odd can be calculated based on a number of players who have contributed chips in the pot and a total number of the lead outs. In some embodiments, the payout odd may be calculated further based on a number of the lead out(s) covered by the insurance, using probabilities associated with each number of the lead out(s), and derivatives associated with the probabilities. For example, in a situation of a two-player pot with three lead outs in total, the payout odd of the insurance may be 6.5. In a situation of a three-player pot with three lead outs in total, the payout odd of the insurance may be 6. In one embodiment, when the calculated payout odd is lower than 1, the option to purchase insurance is not provided as shown in FIG. 3. It should be noted that it may be possible to not collect the user-designated insurance premium from the leading player instantly after the leading player decides to purchase the turn-card insurance.

In some embodiment, there is a condition that a payout of the insurance does not exceed a current size of the pot. In one example of FIG. 4, when the current size of the pot is 400 chips and the payout odd is 3, the insurance premium that can be deployed by the leading player is capped at 400/3˜=133 chips.

In step S6, the processor 12 determines whether the turn-card insurance is purchased by any player.

Specifically, in cases that only one pot is present, the processor 12 determines whether the turn-card insurance is purchased by the leading player of the pot. In cases where a plurality of pots are present, when it is determined that the leading player of at least one pot has purchased the turn-card insurance in step S6, the flow proceeds to step S7. Otherwise, i.e., all leading player(s) of all pot(s) did not purchase the turn-card insurance, the flow proceeds to step S25, in which the game proceeds to the turn stage.

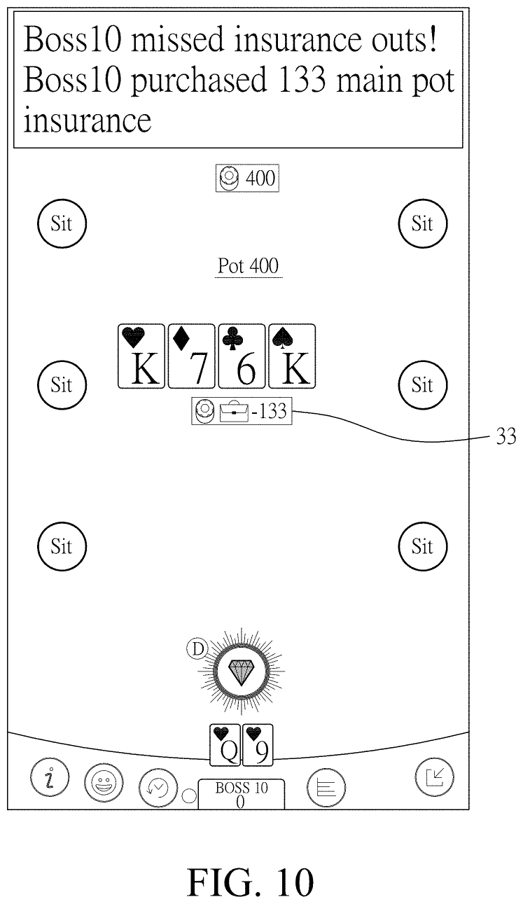

In step S7, for each purchased turn-card insurance, the processor 12 records the insurance premium and the lead out(s) that is covered by the turn-card insurance. The purchase may be shown on the virtual table (see for example FIG. 10, in which a suitcase icon 33 indicates that turn-card insurance is purchased).

In step S8, the game proceeds to the turn stage, that is, the turn card is dealt face up, and another betting round is held. Then, steps S9-S11 are implemented with respect to each individual leading player who has purchased the turn-card insurance. In step S9, the processor 12 determines whether the turn card actually dealt in step S8 is a lead out covered by the turn-card insurance. When the determination made in step S9 is affirmative, the flow proceeds to step S10, in which the leading player is paid a payout, an amount of which is calculated based on the user-designated insurance premium and the payout odd. Specifically, the amount of the payout is calculated by multiplying the first payout odd by the user-designated insurance premium. When it is determined in step S9 that the turn card dealt in step S8 is not a lead out covered by the turn-card insurance, the flow proceeds to step S11, in which the processor 12 records that the insurance premium is to be collected from the leading player. One exemplary case is shown in FIG. 10 where the player Boss 10 is notified that the turn card currently dealt is not a insurance-covered lead out. In some embodiments, the insurance premium is deducted from the pot after the game. In some embodiments, the insurance premium is deducted from the stack of the leading player.

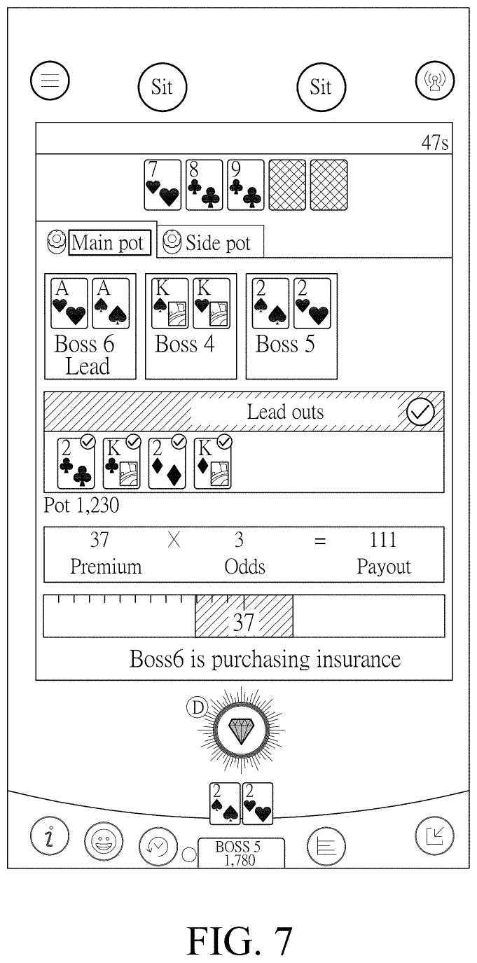

It is noted that in some cases, multiple pots with all-in bets may be present. As shown in FIG. 7, a main pot of the game may be associated with three players (namely, the players Boss 4, Boss 5 and Boss 6). At the flop stage, the player Boss 6 is currently the leading player of the main pot with an Ace pair, and there are four lead outs (two Kings that would make the player Boss 4 the leading player in the next stage, and two deuces (twos) that would make the player Boss 5 the leading player in the next stage). In this case, the player Boss 6 is provided with the option to purchase insurance against one or more of the four lead outs.

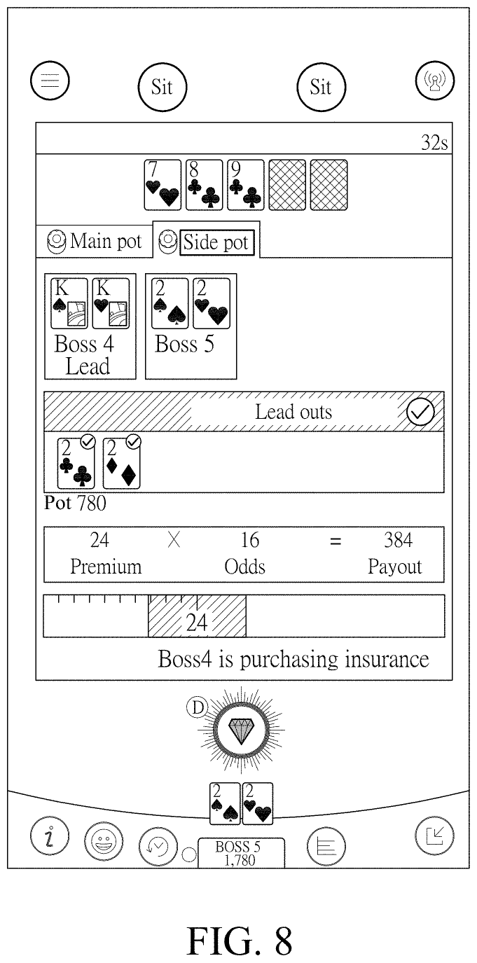

Additionally, as shown in FIG. 8, in the same game as that shown in FIG. 7, a side pot of the game may be associated with two players (namely, the players Boss 4 and Boss 5). At the flop stage, the player Boss 4 is currently the leading player of the side pot with a King pair, and there are two lead outs (two deuces that would make the player Boss 5 the leading player in the next stage). In this case, the player Boss 4 is provided with the option to purchase insurance against one or more of the two lead outs.

In some embodiments, in addition to lead outs, the processor 12 further determines whether a chop out exists. Specifically, the term “chop out” refers to a card in the stack of cards that is not yet dealt and that, when dealt in the turn stage, enables another player to have a hand with the same rank as the hand of the leading player.

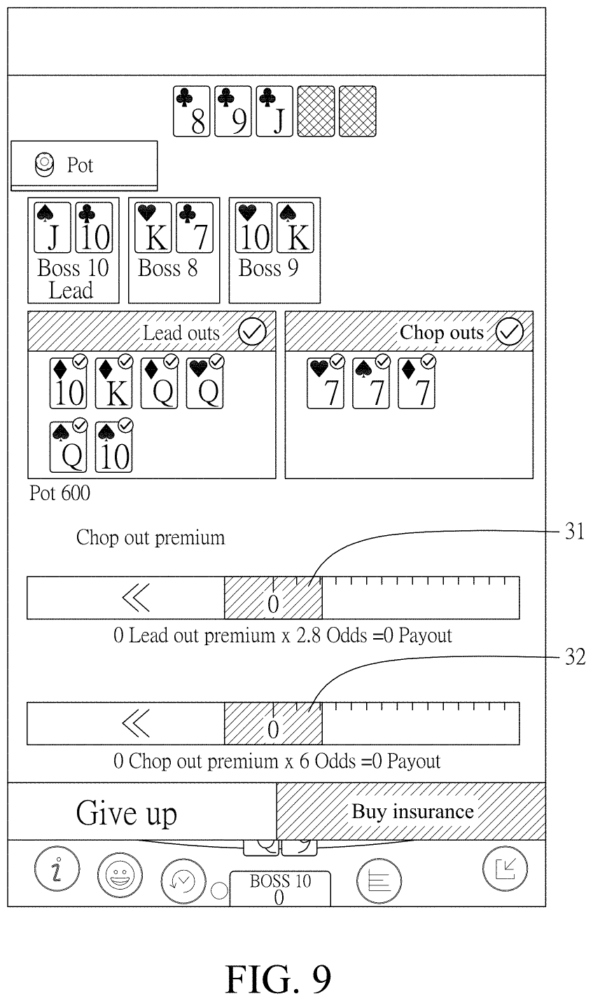

In one example shown in FIG. 9, the pot of the game may be associated with three players (namely, the players Boss 8, Boss 9 and Boss 10). At the flop stage, the player Boss 10 is currently the leading player of the pot with a Jack pair, and there are six lead outs (two tens that would make the player Boss 9 the leading player in the next stage, three Queens that would make the player Boss 9 the leading player in the next stage, and one King that would make both the players Boss 8 and Boss 9 leading players in the next stage). In addition, there are three chop outs (three sevens that would make both the players Boss 9 and Boss 10 leading players alongside the player Boss 10 in the next stage). In the buy insurance window, the lead outs and the chop outs may be displayed in separate groups to notify the leading player. The leading player may be given a “select all” option to select the entire group of the lead outs and/or the chop outs.

In this case, the player Boss 10 is provided with the option to purchase insurance against one or more of the six lead outs using the slider bar 31, and/or one or more of the three chop outs using another slider bar 32.

After step S10, the flow proceeds to step S12.

It is noted that, after step S21 (for cases that no all-in bet occurs in the flop stage), the processor 12 determines whether an all-in bet has occurred (step S22). When it is determined in step S22 that an all-in bet has occurred, the flow proceeds to step S12. Otherwise, the flow proceeds to step S23, in which the game proceeds to the river stage.

Additionally, after steps S24 and S25, the flow also proceeds to step S12.

In step S12, the processor 12 determines whether a predetermined insurance condition is met. When it is determined that the insurance condition is met, the flow proceeds to step S13. Otherwise, the flow proceeds to step S26, in which the game proceeds to the river stage. It is noted that because a new card (the turn card) is dealt in the turn stage (step S21, S21, S25 or S8), the leading player for each pot may have changed.

In step S13, the processor 12 provides each leading player (the leading player for each pot) with an option to purchase insurance against at least one lead out with a user-designated insurance premium. For example, a“buy insurance” window may pop up at the display 22 of the electronic device 2 of the leading player. Additionally, the processor 2 calculates a second payout odd associated with the insurance against the at least one lead out in step S13. Similarly, the user-designated insurance premium is not necessarily collected from the leading player instantly after the leading player decides to purchase insurance. It should be noted that the second payout odd is calculated in a manner similar to the calculation of the first payout odd.

It is noted that in the insurance purchased in the turn stage covers only the next dealt card (i.e., the river card), and is referred to as river-card insurance hereinafter.

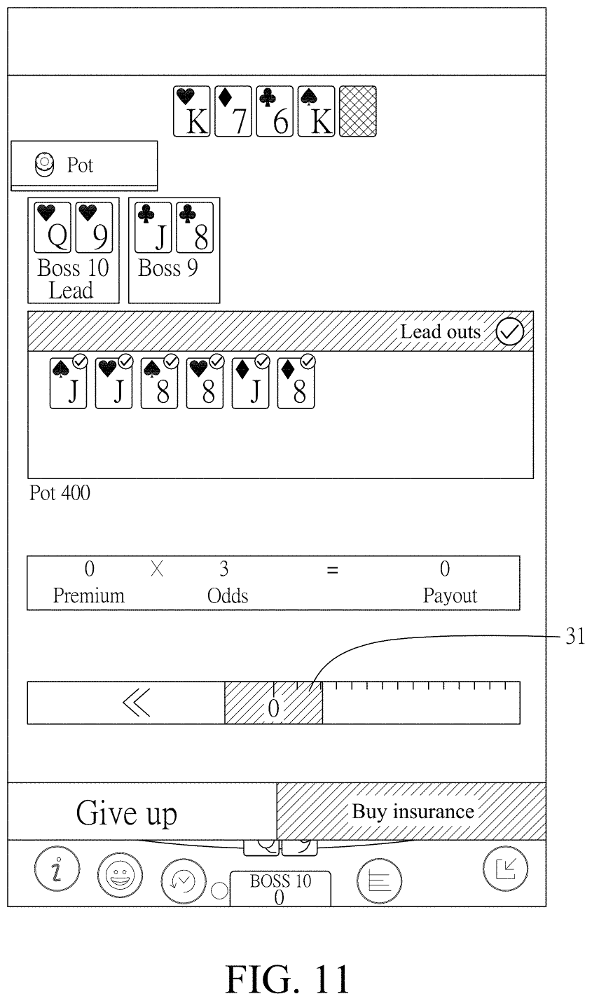

In one example shown in FIG. 11, the pot of the game may be associated with two players (namely, the players Boss 9 and Boss 10). At the turn stage, the player Boss 10 is currently the leading player of the pot with a King pair and a Queen, and there are six lead outs (three Jacks and three eights that would make the player Boss 9 the leading player in the next stage). In this case, the player Boss 10 is provided the option to purchase the river-card insurance against one or more of the six lead outs. Similarly, in the event that the player Boss 10 decides to purchase the river-card insurance in this stage, the player Boss 10 may further decide which lead out(s) would be covered by the river-card insurance.

When it is determined, in step S14, that the river-card insurance is purchased by any player in step S13, the flow proceeds to step S15. Otherwise, the flow proceeds to step S26, in which the game proceeds to the river stage.

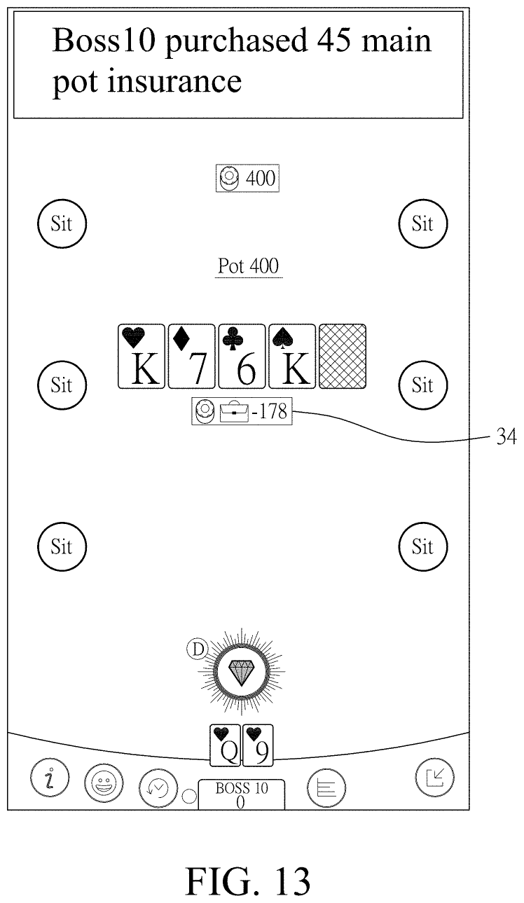

In step S15, for each purchased river-card insurance, the processor 12 records the user-designated insurance premium and the lead out(s) that is covered by the river-card insurance. The purchase may be shown on the virtual table (see for example FIG. 13, in which a suitcase icon 34 indicates that the river-card insurance is purchased and an amount of insurance premium of 178 chips is displayed).

In step S16, the game proceeds to the river stage, that is, the river card is dealt face up, and another betting round is held. Then, steps S17-S19 are to be implemented with respect to each individual leading player who has purchased the river-card insurance. In step S17, the processor 12 determines whether the river card is a lead out covered by the river-card insurance. When the determination is affirmative, the flow proceeds to step S18, in which the leading player is paid a payout based on the user-designated insurance premium and the second payout odd. Specifically, the processor 12 calculates an amount of the payout by multiplying the second payout odd by the user-designated insurance premium. Otherwise, the flow proceeds to step S19, in which the processor 12 records that the insurance premium is to be collected from the leading player. In some embodiments, the insurance premium is deducted from the pot after the game. In some embodiments, the insurance premium is deducted from the stack of the leading player.

Afterward, the flow proceeds to step S20, in which the game proceeds to a showdown. On the showdown, each player who has not folded yet reveals his or her hole cards to make a best five card poker hand that is selected from the two hole cards and the five community cards and that is a subset of the two hole cards and the five community cards. In the case that multiple pots are present, a winner of each of the pots is determined separately among the respective associated players.

It is noted that after steps S23 and S26, the game also proceeds to the showdown.

It is noted that in a case that the player Boss 10 who is the leading player in both the flop stage and the turn stage purchased only the turn-card insurance and did not purchase the river-card insurance, the player Boss 10 has to pay the insurance premium for the turn-card insurance regardless of the outcome of the game. In a case that the player Boss 10 (leading player in both stages) purchased both the turn-card insurance and the river-card insurance, the player Boss 10 has to pay the insurance premium for the turn-card insurance and can get payout when losing the game over a lead out that is actually dealt in the river stage and that is covered by the river-card insurance, and has to pay the insurance premiums for both the turn-card insurance and the river-card insurance when winning the game.

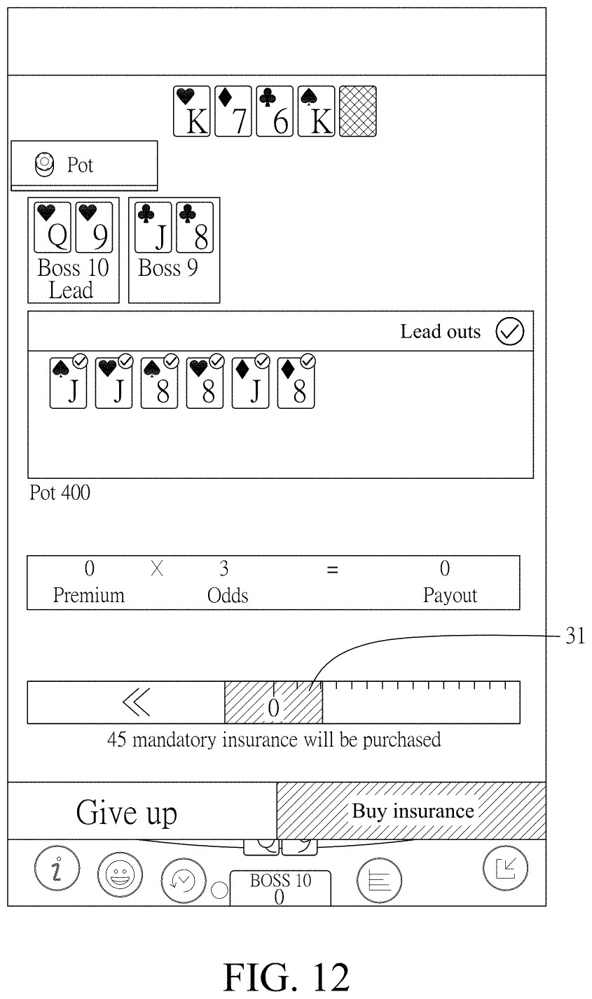

It should be noted that there may be a situation that the player who purchased insurance in the flop stage or the turn stage does not have enough chips to pay the insurance premium. For example, after the leading player has purchased the turn-card insurance at the flop stage, even if the leading player is still leading after the turn stage, there may be a possibility that a lead out is dealt as the river card, making another player the leading player and eventually wining the pot. In the example of FIG. 12, if the other player (Boss 9) wins the showdown and is awarded the pot, there is a possibility that the leading player (Boss 10) who has purchased the turn-card insurance at the flop stage is unable to pay the insurance premium since the leading player has gone all in and does not have enough chips for paying the insurance premium of the turn-card insurance. The following provides a mechanism to prevent such a situation from happening.

In order to ensure collection of the insurance premium, the processor 12 may determine that a mandatory insurance is required for each of the remaining lead outs at the river stage (as seen in FIG. 12, all of the lead outs are selected and locked). It is noted that in order to cover the insurance premium of the turn-card insurance, an expected payout should be at least the same as the insurance premium of the turn-card insurance. As such, an insurance premium floor may be set as a quotient of the insurance premium of the turn-card insurance divided by the payout odd of the mandatory insurance (which may be calculated based on the number of players associated with the pot and the total number of all possible lead outs or a number of lead outs selected by the leading player to purchase insurance).

In the example of FIG. 12, the leading player (Boss 10) has purchased the turn-card insurance with an insurance premium of 133 chips (as seen in FIG. 10).

Since the turn card actually dealt in the turn stage is not one of the lead outs, the insurance premium of 133 chips will be deducted from the pot or the stack. There may be a situation that the river card is one of the lead outs not covered by the river-card insurance, and the player Boss 10 has previously gone all in making his/her stack empty and unable to allow deduction of the insurance premium. In order to prevent this situation, the processor 12 may implement a process for compelling (i.e., forcing) the player Boss 10 to purchase a mandatory insurance against all of the lead outs so as to ensure that when the river card is one of the lead outs, the insurance premium can be collected from the player Boss 10, as the player Boss 10 will be paid a payout should one of the lead outs be dealt or the player will win at least a portion of the pot should a non-lead-out be dealt. In the example, the payout odd in the river stage is 3, such that an insurance premium of the mandatory insurance may be set with a floor of ┌133/3┐=45. It should be noted that the symbol ┌x┐ means the ceiling of x, i.e. the smallest integer greater than or equal to x. The resulting insurance premium may be updated as seen in FIG. 13 showing the total insurance premium of 133+45=178 chips. It is noted that in addition to the mandatory insurance, the leading player may further purchase additional insurance at this stage.

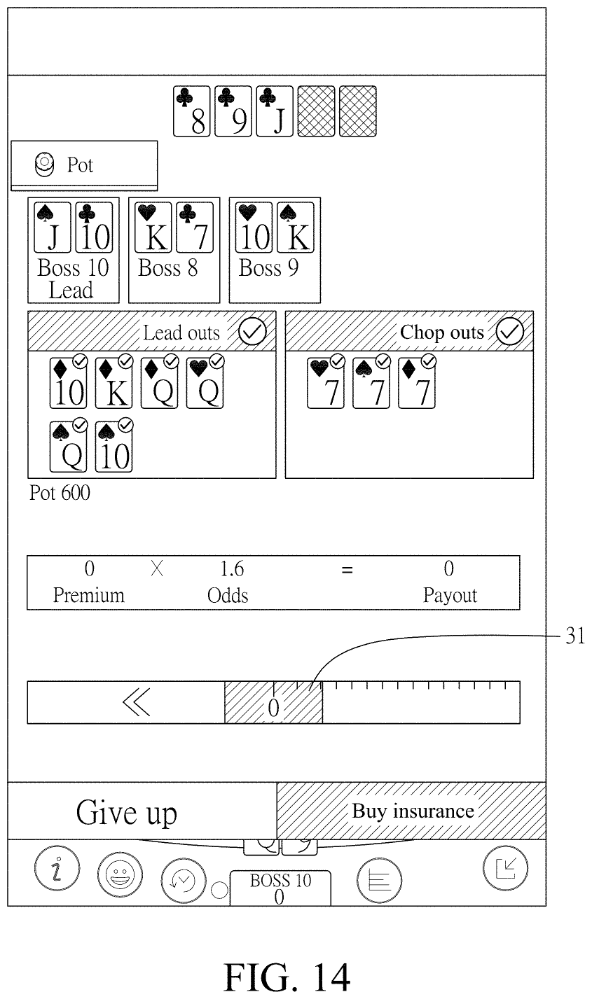

As shown in FIG. 14, in one embodiment, the leading player Boss 10 is given the option to purchase the turn-card insurance against any one of the lead outs and any one of the chop outs. When all the lead outs and the chop outs are selected for the turn-card insurance, no mandatory insurance is imposed.

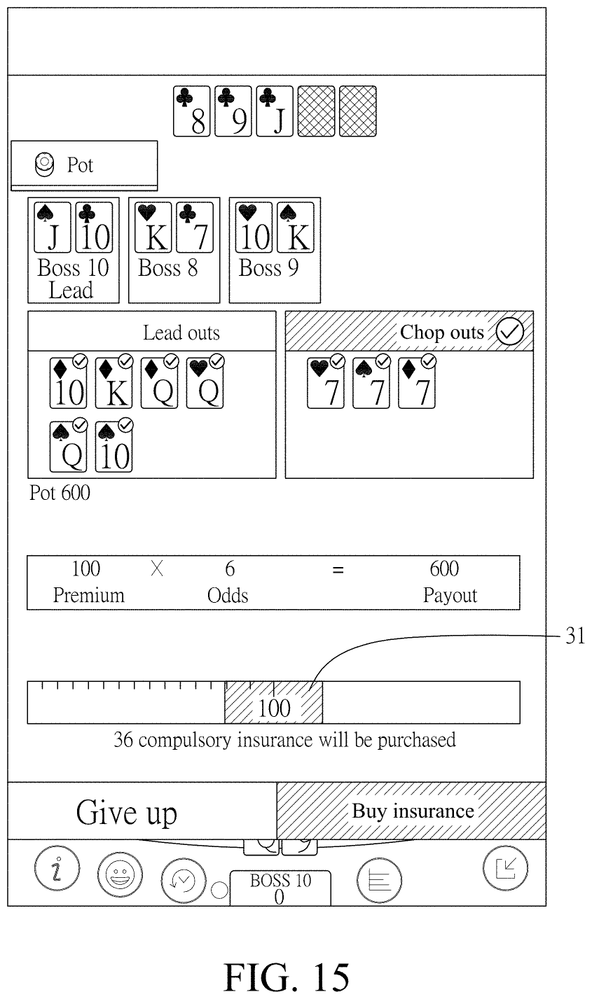

On the other hand, in one case as shown in FIG. 15, after the leading player has confirmed the purchase of the turn-card insurance against the chop outs and not against at least one of the lead outs (in the case of FIG. 15, only the chop outs are selected, and all the lead outs are deselected), the processor 12 may automatically impose a mandatory insurance on the lead outs that are “deselected” (i.e., not covered by the turn-card insurance). In this case, when the insurance premium associated with the chop outs is 100 chips, and the payout odd of the lead outs is 2.8, the insurance premium for the mandatory insurance is ┌100/2.8┐=36 chips.

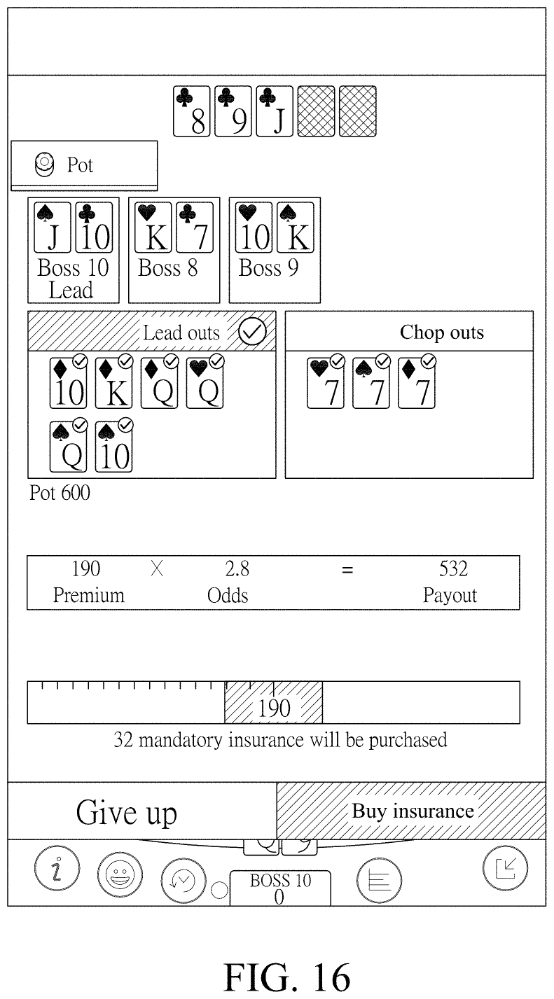

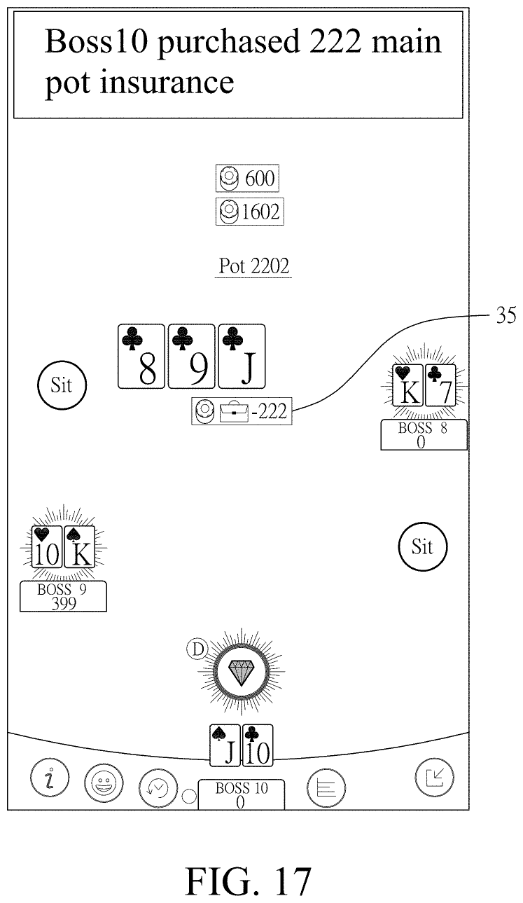

In another case shown in FIG. 16, the leading player Boss 10 purchased the turn-card insurance in the turn stage against the lead outs and not against the chop outs. In such case, the processor 12 may automatically impose a mandatory insurance on the chop outs that are deselected. In this case, when the insurance premium of the turn-card insurance is 190 chips and the payout odd of the chop outs is 6, the insurance premium for the mandatory insurance is ┌190/6┐=32 chips. The result of such purchase may be updated on the virtual table (see for example FIG. 17, in which a suitcase icon 35 indicates that insurance is purchased, and the amount of insurance premium is increased to 222 chips).

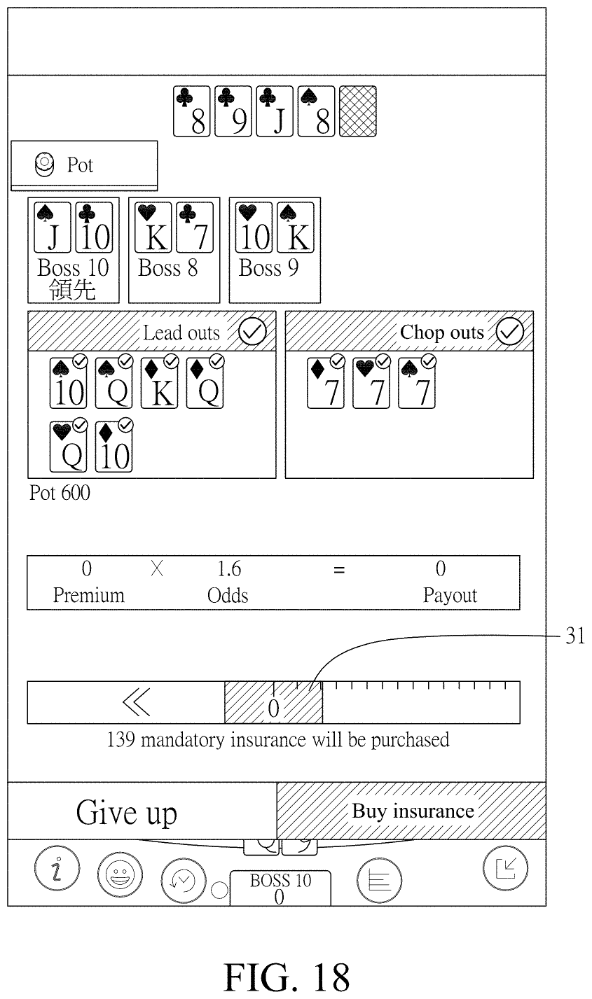

In the turn stage, as shown in FIG. 18, a spade eight is dealt as the turn card, which is not one of the lead outs or chop outs. As a result, the insurance premium of 222 chips (see the example of FIG. 17) is due after the game.

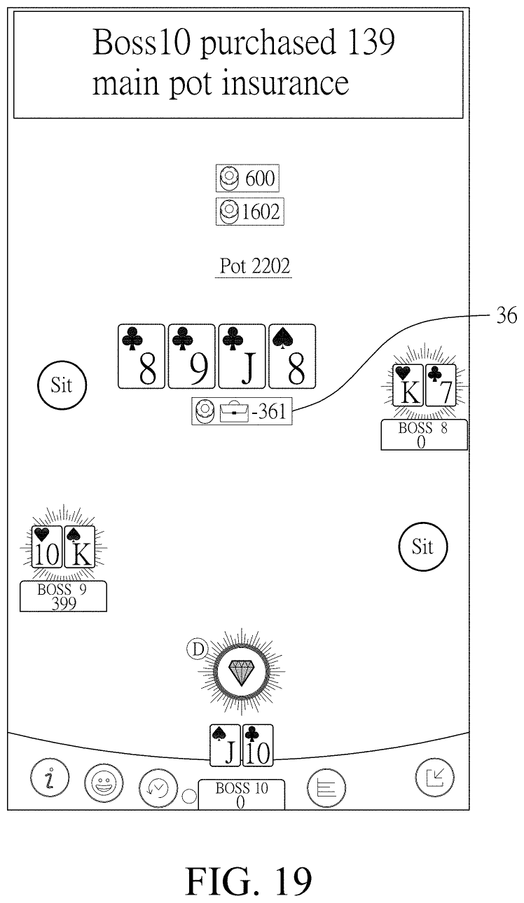

In this case, in order to eliminate the possibility of the leading player Boss 10 deselecting any one of the lead outs or chop outs for the river-card insurance in the turn stage, and ending up losing the game because the deselected one(s) of the lead outs or chop outs is dealt as the river card, the processor 12 may impose a mandatory insurance for the lead outs and the chop outs. Specifically, the payout odd of the lead outs and the chop outs is 1.6, and the insurance premium for the mandatory insurance is ┌222/1.6┐=139 chips. Such insurance purchase may be updated on the virtual table (see for example FIG. 19, in which a suitcase icon 36 indicates that insurance is purchased, and the amount of insurance premium is increased to 222+139=361 chips).

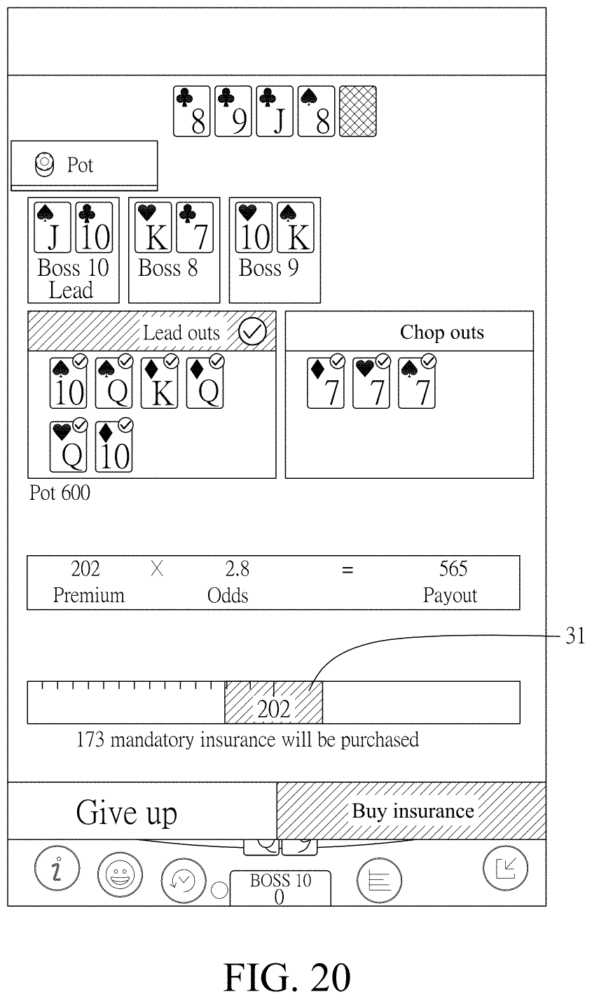

Additionally, when the leading player Boss 10 further purchases the river-card insurance for some of the lead outs or chop outs at this stage, the mandatory insurance may be imposed on the deselected lead outs or chop outs. In one example shown in FIG. 20, the insurance premium for the river-card insurance against all of the lead outs for the river card is 202 chips, the payout odd of the chop outs is 6, the insurance premium for the mandatory insurance of the chop outs may be ┌202/6┐=34 chips. The resulting amount of insurance premium is increased to 222+139+202+34=595 chips.

In one embodiment, in the condition that the payout of the insurance does not exceed the amount of the pot (i.e., a maximum insurance premium that can be deployed by the user for the turn-card insurance is imposed), and that a total insurance premium for the turn-card insurance and the river-card insurance does not exceed the amount of the pot, the case that the payout odd in the turn stage (i.e., for the river card) becomes smaller than the payout odd in the flop stage (i.e., for the turn card) is taken into consideration. In such a case, the insurance premium for the turn-card insurance, when too large, may not be recovered by buying mandatory insurance whose payout is not enough to cover the insurance premium for the turn-card insurance.

Under this circumstance, a cap of the insurance premium that can be deployed for the river-card insurance may also be imposed.

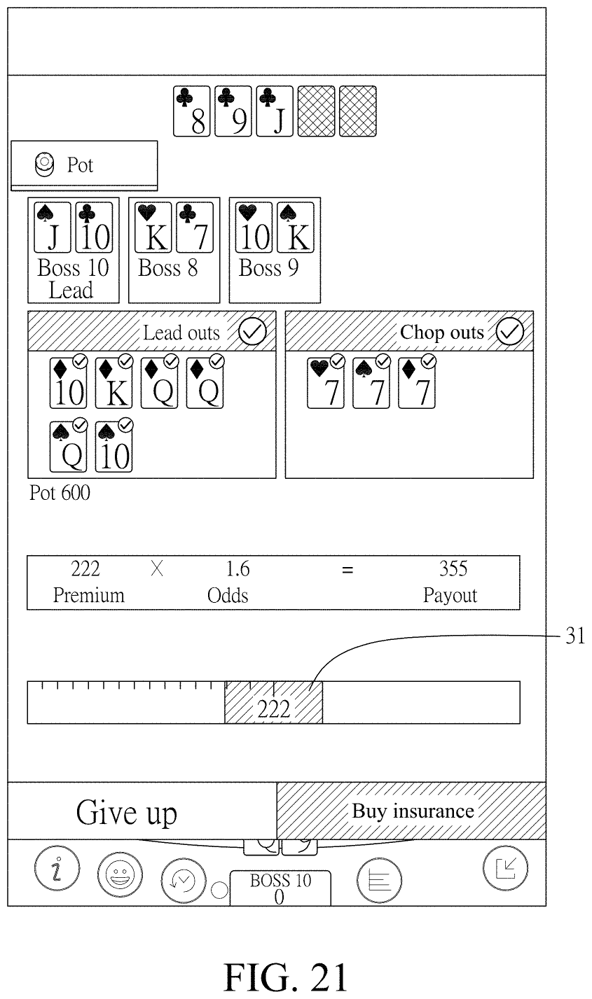

In one example of FIG. 21, three players are associated with the pot, and the amount of the pot is 600 chips. At the flop stage, there are six lead outs and three chop outs. In such a case, the payout odd is 1.6, and a potential lowest payout odd in the turn stage is 0.6. That is to say, while normally the leading player Boss 10 may deploy 600/1.6=375 chips as the insurance premium, in view of the difference between the payout odds in the flop stage and the turn stage, there may be a case in which the insurance premium of the turn-card insurance cannot be completely covered by purchasing river-card insurance (a number of chips allowed for purchase being also capped).

As a result, the insurance premium cap may be defined as a fraction of the amount of the pot, to satisfy the relation that a cap of the insurance premium for the river-card insurance multiplied by the potential lowest payout (i.e., 0.6) is no less than a cap of the insurance premium for the turn-card insurance. The relationships may be expressed as follows:

E*C≤(E−A)*D

E*C≤(E−(E*C))*D

where E represents the amount of the pot, C represents the fraction, A represents the cap of the insurance premium for the turn-card insurance, and D represents the potential lowest payout odd.

Using the above numbers, the fraction for this example may be 0.37 that is rounded down from 0.6/1.6=0.375. That is to say, the insurance premium cap for the turn card is defined as 600*0.37˜=222 chips (as seen in FIG. 21, where the insurance premium is capped at 222 chips).

In one embodiment, there is provided a non-transitory computer readable storage medium storing instructions therein. When executed by a processor of a computer, the instructions may cause the processor to perform operations of the method as described above.

In some embodiments, in determining whether the predetermined insurance condition is met, the processor 12 is configured to determine whether an “out” (which may be either the lead out or the chop out) exists. Subsequently, the option to purchase insurance may be provided against any one of the outs.

To sum up, the embodiments of the disclosure provide a method and a system for hosting a poker game that allows a leading player to purchase an insurance such that when a lead out or chop out is dealt as the turn card or river card, some of the chips may be reimbursed.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for hosting a multi-player poker game with an insurance mechanism, the method to be implemented using a computer system and comprising steps of:
a) initiating the poker game with a plurality of players, the poker game including an initial stage where at least two hole cards are dealt to each of the players from a stack of cards, a flop stage where three community cards are dealt, a turn stage where one additional community card is dealt, and a river stage where one additional community card is dealt, wherein each of the players is permitted to make bet at each stage into at least one pot;
b) after the flop stage and before the turn stage, determining whether an all-in bet has occurred;
c) when the determination of step b) is affirmative, determining whether a predetermined insurance condition is met, the predetermined insurance condition indicating that in the pot, for a leading player who contributed to the pot and has a hand, which is constituted by the hole cards and the community cards, that has a highest rank, there exists at least one lead out in the stack of cards that has not yet been dealt and that, when dealt in the turn stage, enables another one of the players who contributed to the pot to have a hand with a highest rank;
d) when the determination of step c) is affirmative, providing the leading player with an option to purchase a turn-card insurance against the at least one lead out with a user-designated insurance premium; and
e) at the turn stage, when it is determined that the turn card actually dealt is a lead out covered by the turn-card insurance, paying the leading player a payout based on the user-designated insurance premium, and when it is determined that the turn card actually dealt is not a lead out covered by the turn-card insurance, collecting the user-designated insurance premium from the leading player.

2. The method of claim 1, further comprising:
f) after the turn stage and before the river stage, determining whether an all-in bet has occurred;
g) when the determination of step f) is affirmative, determining whether a predetermined insurance condition is met, the predetermined insurance condition indicating that, for a leading player for the pot who has a hand, which is constituted by the hole cards and the community cards, that has a highest rank, there exists at least one lead out in the stack of cards that has not yet been dealt and that, when dealt in the river stage, enables another one of the players who contributed to the pot to have a hand with a highest rank;
h) when the determination of step g) is affirmative, providing the leading player with an option to purchase a river-card insurance against the at least one lead out with a user-designated insurance premium; and
i) at the river stage, when it is determined that the river card actually dealt is a lead out covered by the river-card insurance, paying the leading player a payout based on the user-designated insurance premium, and when it is determined that the river card actually dealt is not a lead out covered by the river-card insurance, collecting the user-designated insurance premium from the leading player.

3. The method of claim 1, further comprising:
when the determination of step b) is negative, proceeding to the turn stage;
f) after the turn stage and before the river stage, determining whether an all-in bet has occurred;
g) when the determination of step f) is affirmative, determining whether a predetermined insurance condition is met, the predetermined insurance condition indicating that, for a leading player for the pot who has a hand, which is constituted by the hole cards and the community cards, that has a highest rank, there exists at least one lead out in the stack of cards that has not yet been dealt and that, when dealt in the river stage, enables another one of the players who contributed to the pot to have a hand with a highest rank;
h) when the determination of step g) is affirmative, providing the leading player with an option to purchase a river-card insurance against the at least one lead out with a user-designated insurance premium; and
i) at the river stage, when it is determined that the river card actually dealt is a lead out covered by the river-card insurance, paying the leading player a payout based on the user-designated insurance premium used to purchase the river-card insurance.

4. The method of claim 1, wherein step c) includes determining a default payout odd for insurance, and the predetermined insurance condition further indicates at least one of the following:
the default payout odd for insurance is larger than a predetermined value;
a size of the pot is larger than a predetermined number; and
only one player is deemed the leading player.

5. The method of claim 2, wherein:
step d) includes determining a first payout odd associated with the turn-card insurance against the at least one lead out;
step e) includes calculating the payout by multiplying the first payout odd by the user-designated insurance premium;
step g) includes determining a second payout odd associated with the river-card insurance against the at least one lead out; and
step i) includes calculating the payout by multiplying the second payout odd by the user-designated insurance premium.

6. The method of claim 3, wherein:
step d) includes determining a first payout odd associated with the turn-card insurance against the at least one lead out;
step e) includes calculating the payout by multiplying the first payout odd by the user-designated insurance premium that was used to purchase the turn-card insurance;
step g) includes determining a second payout odd associated with the river-card insurance against the at least one lead out; and
step i) includes calculating the payout by multiplying the second payout odd by the user-designated insurance premium that was used to purchase the river-card insurance.

7. The method of claim 2, wherein:
step c) further includes determining whether there exists at least one chop out in the stack of cards that has not yet been dealt and that, when dealt in the turn stage, enables another one of the players who contributed to the pot to have a hand with a same rank as the hand of the leading player;
step d) includes further providing the leading player with an option to purchase a turn-card insurance against the at least one chop out;
step g) further includes determining whether there exists at least one chop out in the stack of cards that has not yet been dealt and that, when dealt in the turn stage, enables another one of the players who contributed to the pot to have a hand with a same rank as the hand of the leading player; and
step h) includes further providing the leading player with an option to purchase a river-card insurance against the at least one chop out.

8. The method of claim 2, further comprising:
when it is determined that the leading player purchased the turn-card insurance against the at least one lead out in step d), that the at least one lead out was not dealt in the turn stage, and that the leading player did not purchase the river-card insurance against the at least one lead out in step h), imposing a mandatory insurance for the at least one lead out, wherein an insurance premium for the mandatory insurance is calculated based on the insurance premium deployed in step d).

9. The method of claim 2, further comprising:
when it is determined that the leading player purchased the turn-card insurance against the at least one lead out in step d), that the at least one lead out was not dealt in the turn stage, and that the leading player purchased the river-card insurance against the at least one lead out in step h), imposing an insurance premium floor for the at least one lead out, wherein the insurance premium floor for the river-card insurance is calculated based on the insurance premium deployed in step d).

10. The method of claim 2, further comprising, when
a plurality of lead outs were present in step c),
the leading player purchased the insurance against at least one of the plurality of lead outs in step d), and the at least one of the plurality of lead outs was not dealt in the turn stage, and
the leading player did not purchase the river-card insurance against at least one of the plurality of lead outs in step h),
imposing a mandatory insurance for the deselected at least one of the plurality of lead outs that is not covered by the river-card insurance, wherein an insurance premium for the mandatory insurance is calculated based on the insurance premium deployed in step d).

11. The method of claim 2, wherein:
step c) further includes determining whether there exists at least one chop out in the stack of cards that has not been yet dealt and that, when dealt in the turn stage, enables another one of the players who contributed to the pot to have a hand with a same rank as the hand of the leading player;
the method further comprising when
a plurality of lead outs and a plurality of chop outs were present in step c),
the leading player purchased the insurance against at least one of the plurality of lead outs or chop outs in step d), and the at least one of the plurality of lead outs or chop outs was not dealt in the turn stage, and
the leading player did not purchase the river-card insurance against at least one of the plurality of lead outs or chop outs in step h),
imposing a mandatory insurance for the at least one of the plurality of lead outs or chop outs against which the river-card insurance was not purchased, wherein an insurance premium for the mandatory insurance is calculated based on the insurance premium deployed in step d).

12. The method of claim 11, wherein in step h), the insurance premium floor is calculated as a quotient of the insurance premium used to purchase the turn-card insurance divided by a payout odd of the mandatory insurance.

13. The method of claim 2, wherein:
step d) includes imposing a first insurance premium cap that can be deployed by the user for the turn-card insurance; and
step h) includes imposing a second insurance premium cap that can be deployed by the user for the river-card insurance, the first and second maximum insurance premiums being related to a potential lowest payout odd and an amount of the pot.

14. The method of claim 2, further comprising, when
a plurality of lead outs were present in step c),
the leading player did not purchase the insurance in step d), and
the leading player purchased an insurance against some of the plurality of lead outs in step h),
imposing a mandatory insurance for at least one of the plurality of lead outs against which the insurance was not purchased, wherein an insurance premium for the mandatory insurance is calculated based on the insurance premium deployed in step h).

15. The method of claim 3, further comprising, when a plurality of lead outs were present in step c), and when the leading player purchased an insurance against some of the plurality of lead outs in step h), imposing a mandatory insurance for at least one of the plurality of lead outs against which the insurance was not purchased, wherein an insurance premium for the mandatory insurance is calculated based on the insurance premium deployed in step h).

16. A computer system for hosting a multi-player poker game, comprising:
a database that stores a software application therein;
a communication component that is configured to communicate with a plurality of electronic devices, each being operated by a player; and
a processor electrically connected to said database and said communication component, and configured to execute the software application so as to perform the steps of the method of claim 1.

17. A non-transitory computer readable data storing medium storing instructions therein that when executed by a processor of a computer, cause the processor to perform steps of the method of claim 1.
